(19) United States
(12) Patent Application Publication
(10) Pub. No.: US 2011/0145056 A1
(43) Pub. Date: Jun. 16, 2011

(54) INTERACTIVE ONLINE CLOSED LOOP MARKETING SYSTEM AND METHOD

(75) Inventors: Francis Sullivan, Round Rock, TX (US); Scott Abel, Austin, TX (US); Kevin Schell, Rollingwood, TX (US)

(73) Assignee: SPICEWORKS, INC., Austin, TX (US)

(21) Appl. No.: 12/967,446

(22) Filed: Dec. 14, 2010

Related U.S. Application Data
(63) Continuation-in-part of application No. 12/041,480, filed on Mar. 3, 2008.

(51) Int. Cl. G06Q 30/00; G06F 15/173

(52) U.S. Cl. 705/14.41; 705/14.73; 709/224

(57) ABSTRACT

An interactive online closed loop marketing system and method for marketing of a technical product or service product to companies and/or users of a plurality of network management systems is provided. A database populated with anonymous aggregate IT asset inventory information, user information, and company information (gathered and aggregated through the network management systems) is queried by a third party to evaluate and analyze the potential market for the technical product or service. The system and method further permit the third party to develop a survey and deliver the survey to users of the network management system via the network management system thereby permitting the third party to further quantify and analyze the potential market opportunity. Additionally, the system and method permit the third party to target advertising for the product or service directly to end users via the network management system while tracking the effectiveness of the advertising campaign.

### RELATED APPLICATIONS

This application claims priority to and is a continuation in part of pending U.S. patent application Ser. No. 12/041,480 “SYSTEM AND METHOD FOR HARDWARE AND SOFTWARE MONITORING WITH INTEGRATED RESOURCE ACQUISITION” by Francis Sullivan and filed on Mar. 3, 2008, which is incorporated herein by reference in its entirety and made part of the present U.S. Utility patent application for all purposes.

### FIELD

The present disclosure relates to marketing and product development and more specifically to methods and systems for managing a product lifecycle utilizing an online network management system.

### BACKGROUND

Taking a product from idea to market is a time consuming process. And decisions made throughout this process, from modeling market size to branding, often require access to large amounts of consumer data—whether this data relates to current consumer product use or consumer surveys aimed at predicting product sales.

It is increasingly important for information technology (IT) product developers to be able to properly identify a market in order to target a potential customer base and build a business model. Identifying and valuing a market opportunity includes gathering data on the needs of potential customers and other data such as customer attitudes and purchase histories for specific products and vendors. Currently, this data is difficult and costly to obtain for the average product developer. Generally obtaining this sort of information is quite costly and time consuming, especially when one considers the time it would take to properly segment the data (e.g. industry, geography, product usage, type of consumer, etc.). Even after the data is accumulated and segmented, it still requires significant time and energy to review the data and formulate it into a usable format. Regardless, this type of information is normally cost prohibitive for small to medium companies.

Continuing, for any new product offering it is critical for the product developer to obtain information directly from the potential customers regarding important product features, price point, potential demand, best promotion practices, etc. Traditionally, this was performed by telephone or mail surveys. However, this type of data gathering is very costly and time consuming. The product developer must engage a polling company to design a “survey”, identify survey participants, deliver the survey, and collate the data. There is always significant concern that the survey participants were not a part of the potential market group or otherwise misled the survey taker. Additionally, there is tremendous difficulty in obtaining enough participants to have a statistically relevant sample size to validate the received data (most people find this type of surveying intrusive and the number of people refusing to participate increases daily). Even for companies that can afford such services, the current process of surveying greatly extends the time to market.

The product development life cycle then continues to building and executing a marketing campaign. Here it is critical for product developers to deliver their promotional message effectively to targeted customers through properly placed advertisements. The product developer takes the information from the survey and refines the product offering and engages a marketing firm to begin developing an advertising campaign. It is increasingly difficult to provide highly targeted advertising. For products with broad appeal, this is not a huge problem, however, for products with limited or narrowly defined appeal, properly targeting advertising can be very difficult and costly (e.g. IT products). It is not sufficient to merely design and deliver an advertising campaign, the results of the ad campaign must be tracked and quantified to validate not only the ad campaign itself, but all of the marketing steps performed earlier (sales, advertisement performance, return on investment). Once again, this information must be gathered and collated into some usable format at great cost, both in time and money.

### SUMMARY

Therefore a need has arisen for a marketing system and method which provides readily accessible data relating to IT consumers and direct access to those consumers throughout the life cycle of a product offering. In accordance with the disclosed subject matter, a closed loop marketing and product development system and method is provided which substantially eliminates or reduces disadvantages associated with previously developed IT device marketing systems and methods.

According to one aspect of the disclosed subject matter, a method for the closed loop marketing of an IT device is provided which allows a third party access to a database containing information on IT professionals and their IT resources through the IT professionals participation in a network management system.

According to another aspect of the disclosed subject matter, the database contains detailed information on the IT professionals and companies participating in the network management system such as title, experience, company affiliations, purchasing trends, current IT needs, current IT products, type of company, size of company, geographic location, etc.

According to yet another aspect of the disclosed subject matter the system and method provides an intuitive user interface to search, collate, and output information into multiple formats.

According to another aspect of the disclosed subject matter a survey platform provides a user the ability to identify and select highly targeted survey candidates, deliver the survey to the chosen candidates, and collate the survey information into usable information.

According to another aspect of the disclosed subject matter an advertising platform pushes highly targeted advertisements directly to the participants of the network management system.

According to yet another aspect of the disclosed subject matter the system and method perform the above aspects at a significantly lower monetary cost and in a substantially shorter timeframe than traditional methods.

### BRIEF DESCRIPTIONS OF THE DRAWINGS

The accompanying drawings, which are incorporated in and constitute a part of this specification, illustrate several embodiments of the disclosure and together with the description, serve to explain the principles of the disclosure.

For a more complete understanding of the present embodiment, and the advantages thereof, reference is now made to the following brief descriptions, which are to be taken in conjunction with the accompanying FIGUREs, in which like reference numerals indicate like features.

FIG. 1 is a graphic representation of the process flow of an embodiment of the closed loop marketing platform of the present disclosure;

FIG. 2 is a process flow for the closed loop development of an IT product from market opportunity identification to results analysis;

FIG. 3 is a graphic representation of the overall system architecture of an embodiment of the closed loop marketing platform highlighting the integration of marketing platform and network management system;

FIG. 4 is a more detailed graphic representation of the data stored in a network management system database;

FIG. 5 is a graphic representation of the functional architecture of the closed loop marketing platform from both the client's viewpoint and network user's viewpoint;

FIG. 6 is a graphic representation of the overall system architecture from a client's point of view;

FIGS. 7 through 14 are screenshots showing a graphical user interface used to identify and define a market opportunity (screenshots);

FIG. 15 shows a high-level architectural view of disclosed IT network management system;

FIG. 16 is a diagram showing how the disclosed subject matter supports the activities of an IT network administrator;

FIG. 17 is a screenshot showing an initial graphical user interface displaying information helping a network administrator;

FIG. 18 depicts a schematic flow diagram of integrated asset and configuration discovery system of FIG. 15; and

FIG. 19 depicts a schematic diagram of a watcher or monitoring engine.

FIGS. 20A and 20B depict charts of exemplary data depicting the market score feature of the disclosed subject matter.

### DESCRIPTION OF PRESENT DISCLOSURE

The following description is not to be taken in a limiting sense, but is made for the purpose of describing the general principles of the present disclosure. The scope of the present disclosure should be determined with reference to the claims. Preferred embodiments of the disclosed subject matter are illustrated in the FIGUREs, like numerals being used to refer to like and corresponding parts of the various drawings.

In the context of this document, a “memory,” “recording medium,” and “database” can be any means that contains, stores, communicates, propagates, or transports the program and/or data for use by or in conjunction with an instruction execution system (such as a database management system), apparatus, or device. Memory, recording medium, and database can be, but are not limited to, an electronic, magnetic, optical, electromagnetic, infrared or semiconductor system or device. Memory, recording medium, and database also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored. Instruction execution systems (such as a database management system) allow for the creation, maintenance, use, and management of the database and its contents.

Further, the disclosed subject matter may be described in the general context of computer-readable instructions, such as program modules, being executed by a computer. Generally, program modules include routines, programs, objects, components, data structures, etc. that perform particular tasks or implement particular abstract data types. The disclosed subject matter may also be practiced in distributing computing environments wherein tasks are performed by remote processing devices that are linked through a communications network (herein referred to as an “online” network or “online”). Such a distribution method may be achieved through a network-transfer distribution (i.e. internet delivery). In a distributed computing environment, program modules may be located in local and/or remote computer storage media including memory storage devices.

It is the aim of the disclosed system and method to provide critical consumer data and direct access to consumers for the comprehensive product development of an IT product (e.g. from defining and developing a market opportunity to tracking sales results). Consumer data, access to consumers, advertisement methods, and sales reports are available through the use of one interface, a “one-stop shop” for use throughout the product's lifecycle.

The present disclosure includes a method for the closed loop marketing of an IT product and an architecture providing a closed loop marketing and product development platform. The closed loop marketing platform includes a user interface allowing a client to identify, define, and value an IT product by utilizing a network management system. The network management system provides data about users of an IT network and direct access to the users themselves through a user interface. Thus, products may be developed and marketed directly to targeted potential customers. Additionally, the closed loop marketing systems and methods disclosed allow a user to communicate directly with potential customers and track sales/advertisement effectiveness.

Further, the present disclosure includes an architecture providing automatic third party application/license/warranty updates, installations, and purchase options for a user or user community integrated with a network management system. Providing an integrated information sources platform, the presently disclosed system presents contextual views and access for the benefit of both a user community and third party product and service advertisers according to their differing and particular needs. For purposes of the present disclosure, an enterprise may be a company or organization associated through at least one local area network to which computers, peripherals, and other information technology assets and users of such assets may associate.

The disclosed subject matter allows for an inventory of all hardware, software and other assets on a network. The disclosed subject matter allows for discovery of the Windows, Mac, and Linux PCs and servers, routers, printers and any other IP-based devices on a network. All relevant technical data plus the software, patches and services on each machine may be gathered and logged. Other data such as number of licenses, purchase price, and physical location may also be stored. Other assets such as mobile phones, projectors, and office furniture, etc. may also be stored. All of this information may be gathered without the use of agents. All inventory information may be stored locally and securely on the network, avoiding any concerns about sensitive information being communicated over the internet.

The present disclosure, therefore, includes an architecture for interfacing a user community and advertisers/vendors in understanding, monitoring, improving, troubleshooting, and applying IT resources to an enterprise. For purposes of the present disclosure, an enterprise may be a company or organization associated through at least one local area network to which computers, peripherals, and other information technology assets and users of such assets may associate. Providing an integrated information sources platform, the presently disclosed system presents contextual views and access for the benefit of both a user community and product and service advertisers according to their differing and particular needs.

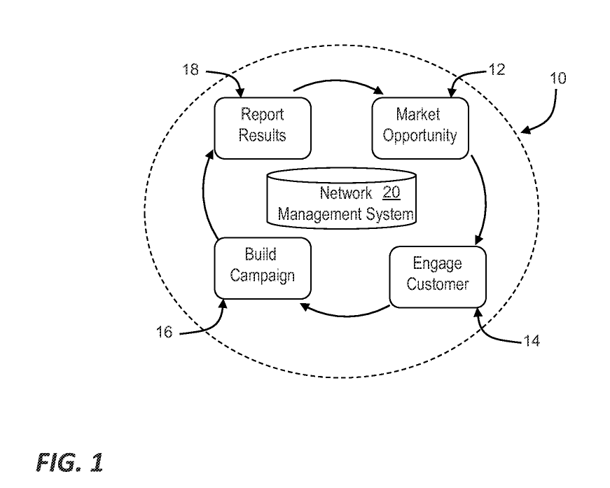

FIG. 1 is a graphic representation of the process flow of an embodiment of the closed loop marketing platform of the present disclosure. Closed loop marketing platform 10 allows a client access to data relating to potential customers and access to the potential customers themselves—users of online network management system 20. Further, closed loop marketing platform 10 provides manageable data to a client from the beginning to end of a product lifecycle in a comprehensive persona driven user interface, thereby collapsing the timeline from product development to return on investment analysis. The features provided—such as those shown in FIG. 1: identify a market opportunity 12, engage the customer 14, build a campaign 16, and report the results 18—allow a client to make accurate and timely decisions regarding their IT product offering.

In operation, the disclosed closed loop marketing system and method provides a comprehensive user interface allowing product developers to first define a market opportunity by segmenting the database of an online network management system. The online network management system provides an IT device inventory monitoring system for a plurality of local networks and as such the online network management system database contains information relating to the IT device use for users of each local network. This data may then be segmented in various ways—such as by network industry (law firm, distributor), geographic region, network size, product usage, or product vendors (Microsoft or Mac)—and analyzed from multiple dimensions in order to identify and quantify a market opportunity for an IT product. User profiles (referred to as consumer personas) may also be identified as primary consumer targets.

Once a targeted consumer is identified, consumers matching the targeted consumer persona may then be surveyed to determine important features for the IT product. Targeted consumers, i.e. those matching a particular consumer profile, are located and directly surveyed. This step is important to identify the product features that are important to the targeted consumer.

When the product is ready for sale, an advertising campaign may then be built to put the product into the market. Campaign information such as advertisement placement and interface zones are designed using the provided user interface and the advertisement is delivered directly to targeted consumers in the network management system.

Reports may then be provided quantifying sales results to target consumers in the network management system. These result reports provide information such as brand measures, ad performance, and sales statistics and may also be segmented by customer type, network industry, geographic region, network size, product usage, or product vendors (Microsoft or Mac) in order to determine the overall return on investment for the IT product.

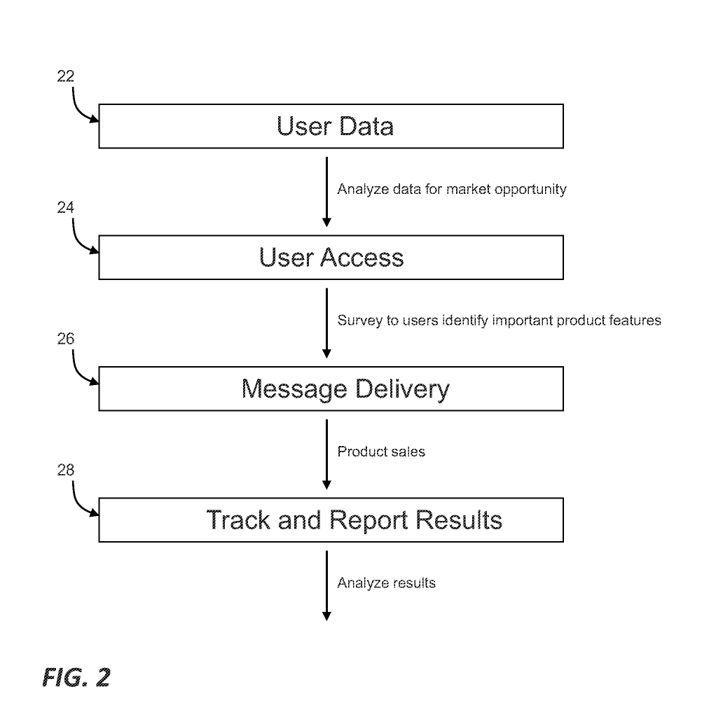

FIG. 2 is a process flow for the closed loop development of an IT product from market opportunity identification to results analysis. First, IT product developers are provided access to user data 22 in a network management system. This data may be sorted and organized in various ways in order to identify a market for a product. User access 24 is then provided to allow IT product developers to directly engage potential customers identified earlier in order to identify important product features. An advertisement campaign is then designed and product message 26 is delivered directly to potential customers in the network management system. Sales are tracked (such as by advertisement tracking logic associated with a website link for the advertised IT product) and reported to the IT product developer. These results may then be analyzed and the product/advertisement campaign refined.

Access to user IT data, access to potential customers, message design and deliver, and results reports are all provided to the IT product developer through the same closed loop marketing platform. Thus significantly collapsing the product development timeline.

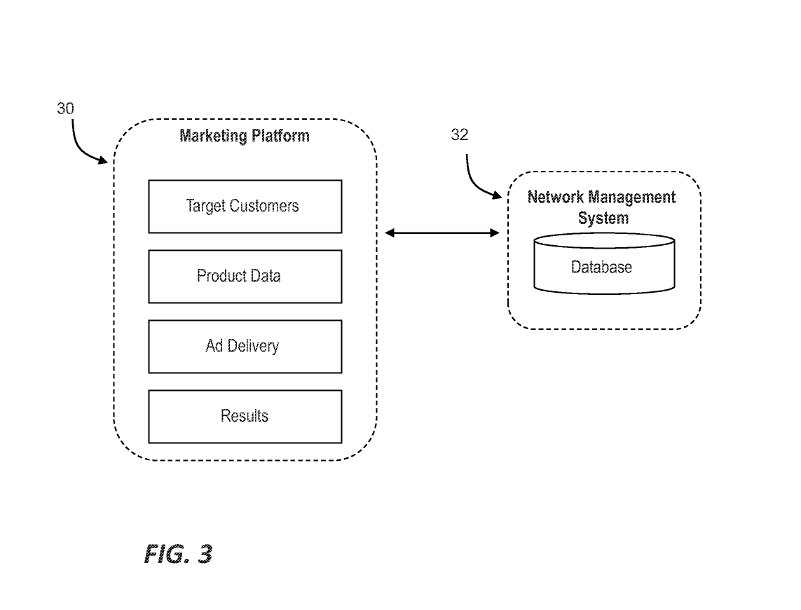

FIG. 3 is a graphic representation of the overall system architecture of an embodiment of the closed loop marketing platform highlighting the integration of marketing platform 30 and network management system 32. Network management system 32 is an online IT monitoring and inventory system for at least one network of users. Network management system 32 comprises a database concerning a plurality of networks and data concerning the users of those networks and a user interface providing updates and alerts to users and IT administrators of the network management system.

Using data from network management system 32, marketing platform 30 allows a client to target customers for a product offering. Information such as IT device use and IT device purchase history may be segmented in order to identify and value a market opportunity. Next, potential consumers may then be directly engaged through 1:1 conversations or surveys to gather product data in order to further identify product features and the most effective product marketing means. Then, product advertisements are delivered to targeted consumers—i.e. advertisements are delivered to IT administrators using network management system 32 or the users of network management system 32 directly through the network management system 32. Finally, results relating to sales, brand measures and advertisement performance are provided based on IT device product sales to users of network management system 32 allowing an accurate return on investment to be calculated. Thus, clients using the disclosed closed loop marketing and product development method and system are able to leverage a network management system to manage an IT product offering from the beginning to end of its lifecycle.

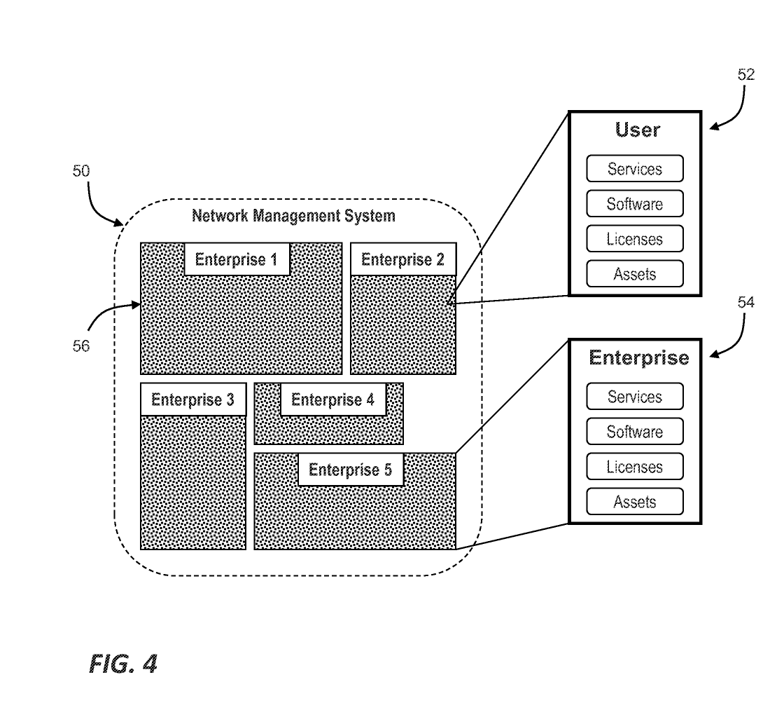

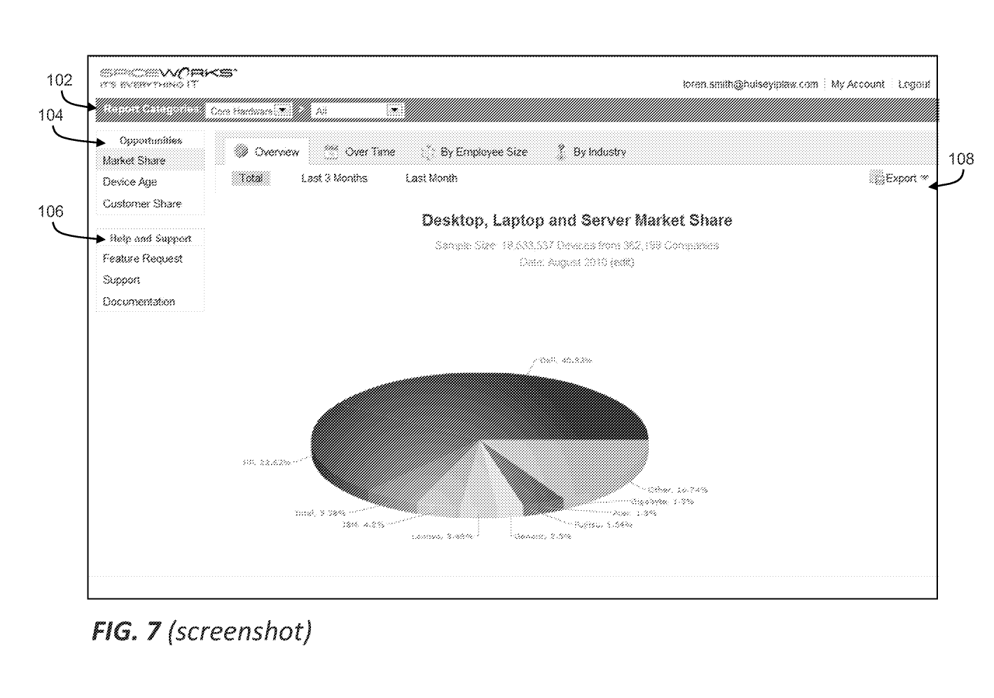

FIG. 4 is a more detailed graphic representation of the data stored in a network management system database. Network management system 50 is an online enterprise IT device monitoring system for a plurality of enterprises of varying sizes. Each enterprise, such as enterprise 56 (Enterprise 1), being comprised of users of a local network, such as user 52 in Enterprise 2. Online network management system 50 provides hardware and software monitoring as well as integrated resource acquisition to local IT networks (known enterprises). Data relating to the software and hardware for each user and each enterprise is stored in a network management system database as a profile, shown in FIG. 4 as user profile 52 and enterprise profile 54. This data includes, for example, information relating to IT services, software applications, software and service licenses, and IT assets such as printers (e.g. see FIGS. 7 through 14). This information may then be analyzed by a third party utilizing the closed loop marketing methods and systems of the present disclosure throughout a product's lifecycle.

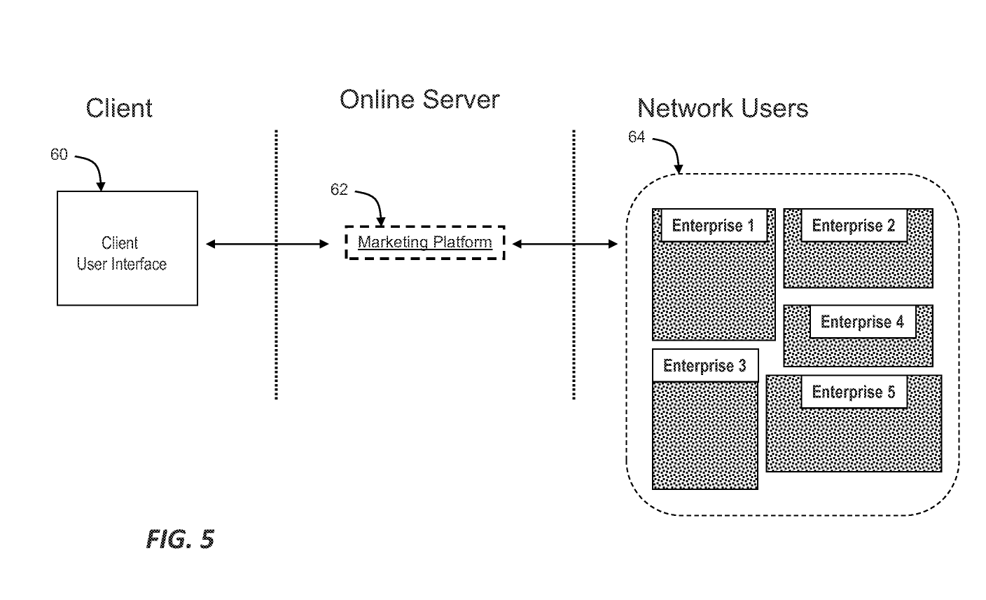

FIG. 5 is a graphic representation of the functional architecture of the closed loop marketing platform from both the client's viewpoint and network user's viewpoint. Client user interface 60 is a persona driven user interface, hosted by marketing platform 62, which provides for the closed loop marketing and product development of an IT product and an online access point (over any IP-based wired or wireless network) to users in a network management system, shown in FIG. 5 as network users 64.

Client user interface 60 allows the client to identify a market opportunity and create an IT product through access to network users and data related to the IT device use of network users. A client is able to use client user interface 60 to engage the customer directly, through surveys and 1:1 conversations, and marketing platform 62 provides the medium through which clients and customers may directly communicate.

Client user interface 60 also allows a client to design an advertisement campaign and deliver messages to targeted network users. Further, client user interface 60 reports sales results of the product to the network users.

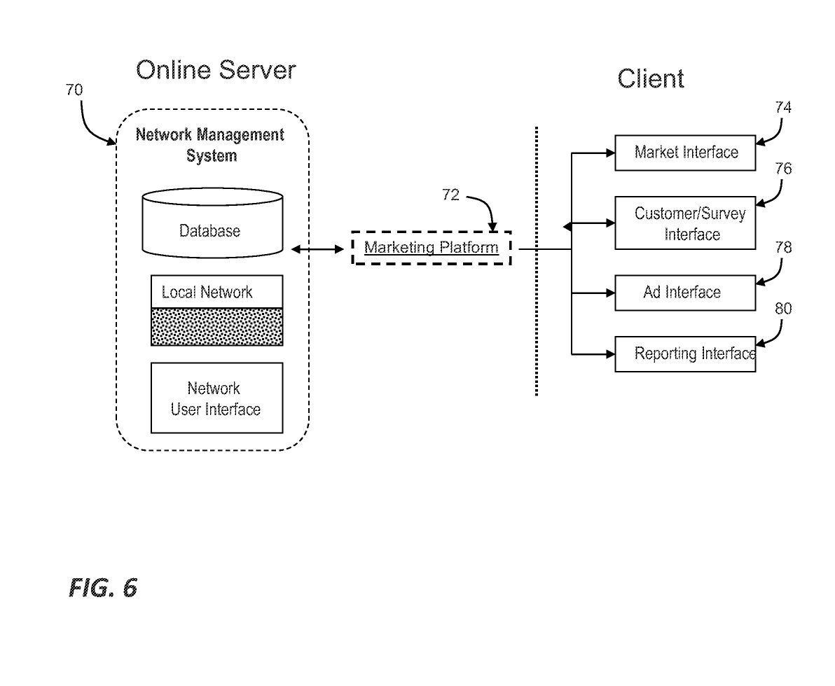

FIG. 6 is a graphic representation of the overall system architecture from a client's point of view. Network management system 70 provides a local network of users, a database having data relating to each user's IT device use and assets, and a network user interface which provides IT device inventory monitoring information to user's and network IT administrators. Marketing platform 72 provides access to both users of the local network and the network management database through online user interfaces. Market interface 74 provides database management control to select personas (particular user profiles) by combining known or learned attributes such as network size, industry, geography, current IT product vendor, and product usage in order to identify and value a market opportunity. Further, market interface 74 provides the ability to model new markets, which may also be segmented as needed.

Additionally, if needed, customer/survey interface 76 allows a client to construct surveys and actively engage users of a local network through the network user interface of network management system 70. Engaging the customer allows a client to further define the product features that matter to consumers and how to effectively package and market the product. By actively soliciting information from a targeted consumer, a client is able to correlate solicited data with network data in the network management system database and determine product data such as product specifics, price, targeted places, and promotion methods.

Ad interface 78 allows the client to develop, target, and plan the product's message delivery. Advertisements may be delivered to targeted users targeted IT administrators for each local network, and/or groups of users and IT administrators based on client criteria (e.g. law firms with 50+ employees). Reporting interface 80 allows a user to track advertisement delivery and sales results while providing and provides tracking reports. Indicators such as brand measures, ad performance, and sales may be segmented by customer type or local network in order to quantify the return on investment for the product offering.

FIGS. 7 through 14 are screenshots showing an embodiment of the graphical user interface of the disclosed closed loop marketing platform used to identify and define a market opportunity. The graphical user interface provides data that may be sorted and viewed in a variety of ways to help a user identify a market opportunity for a particular IT product or service. Options allowing a user to view the data according to use over time, or by local network parameters (such as size, industry, and geographic location), and by manufacturer/software provider are available. These screenshots are intended to show the various ways data may be displayed to a user and are not intended as limiting.

FIG. 7 is a screenshot of a graphical user interface displaying the “Desktop, Laptop and Server Market Share” overview of users of the network management system. A user of the graphical user interface shown in FIG. 7 is able to select through various reporting categories (such as for example: Core Hardware, Network Printers, Networking, Operating System, Productivity, Security/Antivirus, Storage, Virtualization, or VoIP) according to a drop down menu, shown as Core Hardware reference numeral 102. Further, the graphical user interface provides options for the user to sort and view the data selected. Shown, opportunities menu 104 allows the user to view data relating to selected categories: Market Share, Device Age, or Customer Share. The core hardware market share overview data is shown in a pie graph and may further be viewed over various time options—such as by the last 3 months or last month. The user also has the option to view the core hardware market share data Over Time, By Employee Size, or By Industry—each option defining the data's independent variable (such as an x-axis). This data may be exported, shown as Export drop down menu 108, into formats such as XLS and CSV.

Help and Support options 106 allow a user to request features, ask for support, or ask for documentation relating to the data presented.

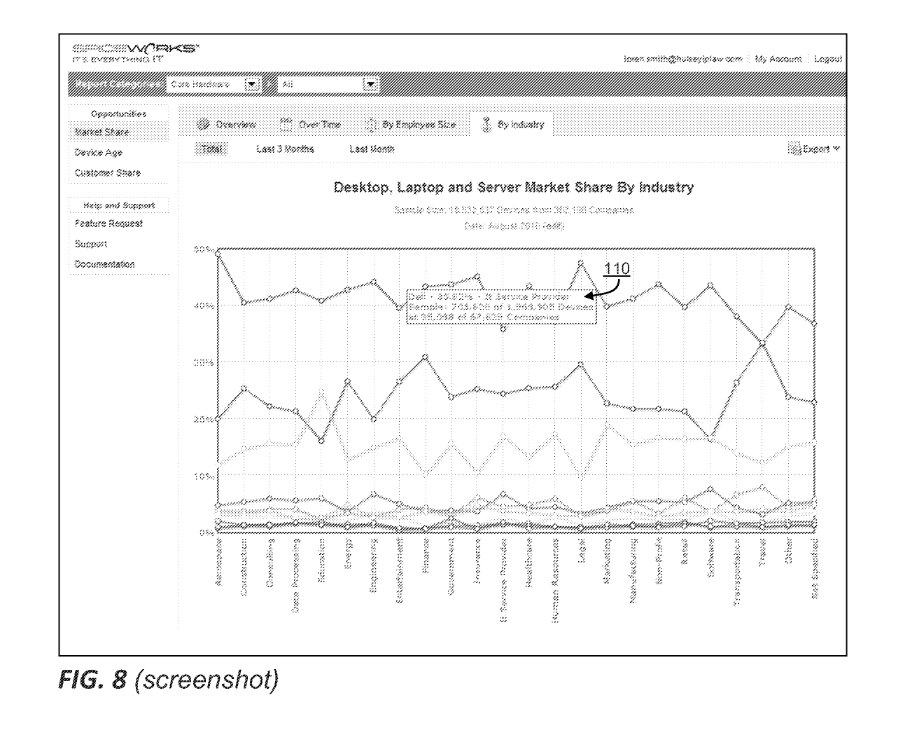

FIG. 8 is a screenshot of a graphical user interface displaying the “Desktop, Laptop and Server Market Share by Industry” of users of the network management system. This information is displayed in a line graph. Mouse fly-over functionality allows a user to select a point on the line graph for additional information related to that data point, shown as data box 110.

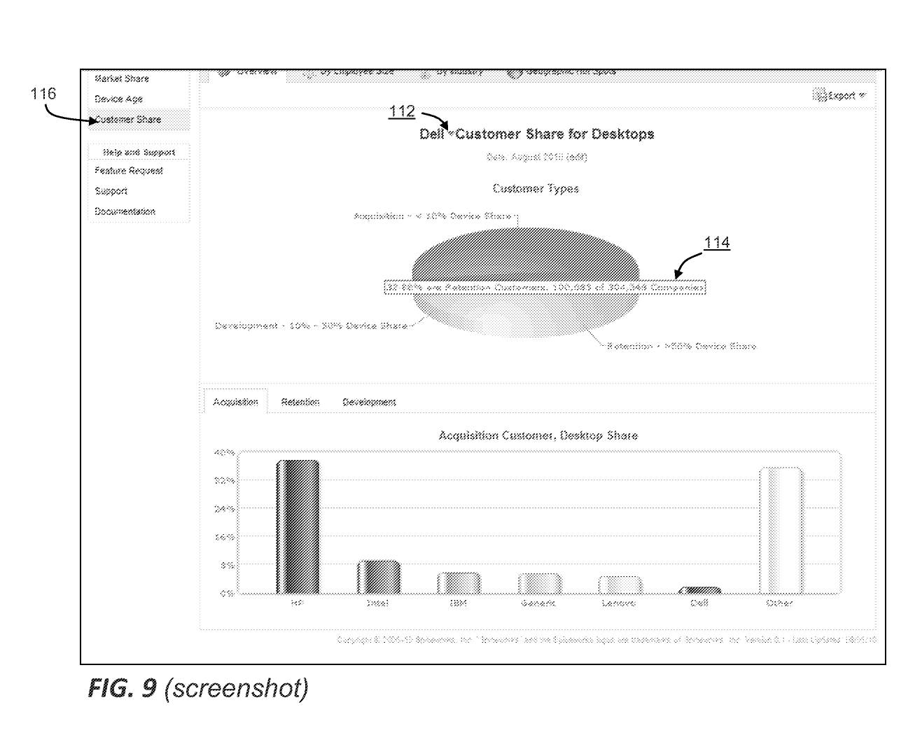

FIG. 9 is a screenshot of a graphical user interface displaying the overview of Customer Share 116 (an option in opportunities menu 104 in FIG. 7) of hardware manufacturers of users of the network management system. Shown, data concerning hardware manufacturer Dell® (Dell is a registered trademark of Dell, Inc.) is shown. This data may be further shown by the hardware use of users of the network management system by Employee Size, Industry, or geographical location of the local network.

Drop down menus 112 allows a user to select other manufacturers of core hardware of users of the network management system. Fly-over data box 114 displays additional information to the user when aspects of the pie graph at the top of the figure or bar graph at the bottom of the figure are selected. A bar graph at the bottom of the figure displays Desktop Share by Acquisition Customer—this data may be also displayed by Retention as well as Development customers.

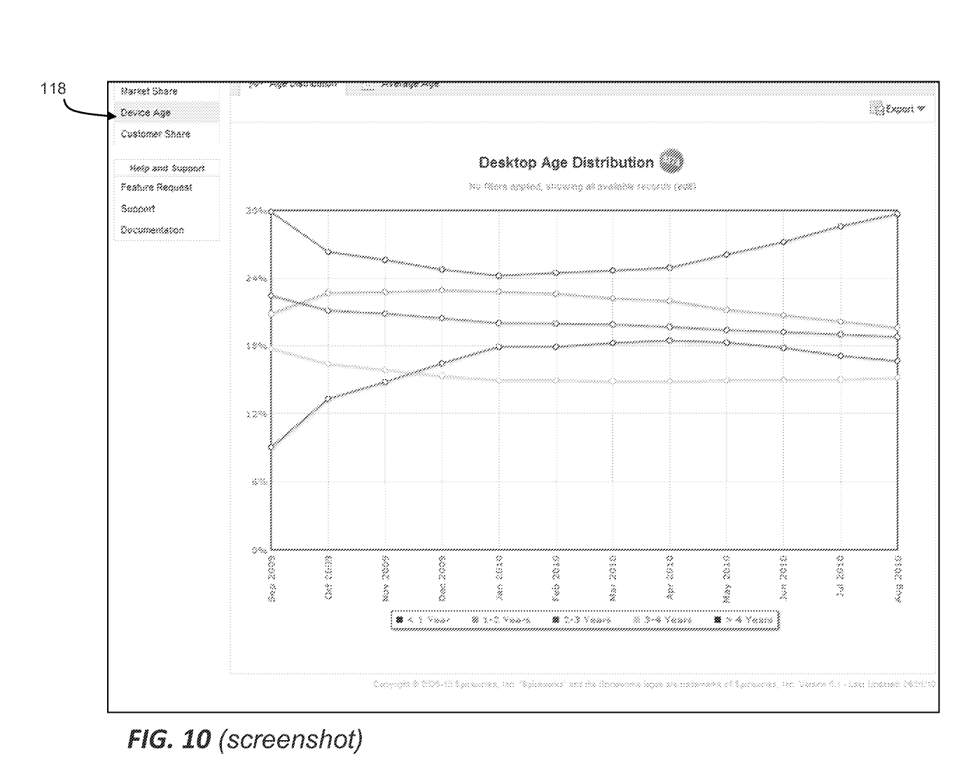

FIG. 10 is a screenshot of a graphical user interface displaying the Device Age 118 (an option in opportunities menu 104 in FIG. 7) age distribution of hardware of users of the network management system. This data may be further shown by the average age of hardware of users of the network management system.

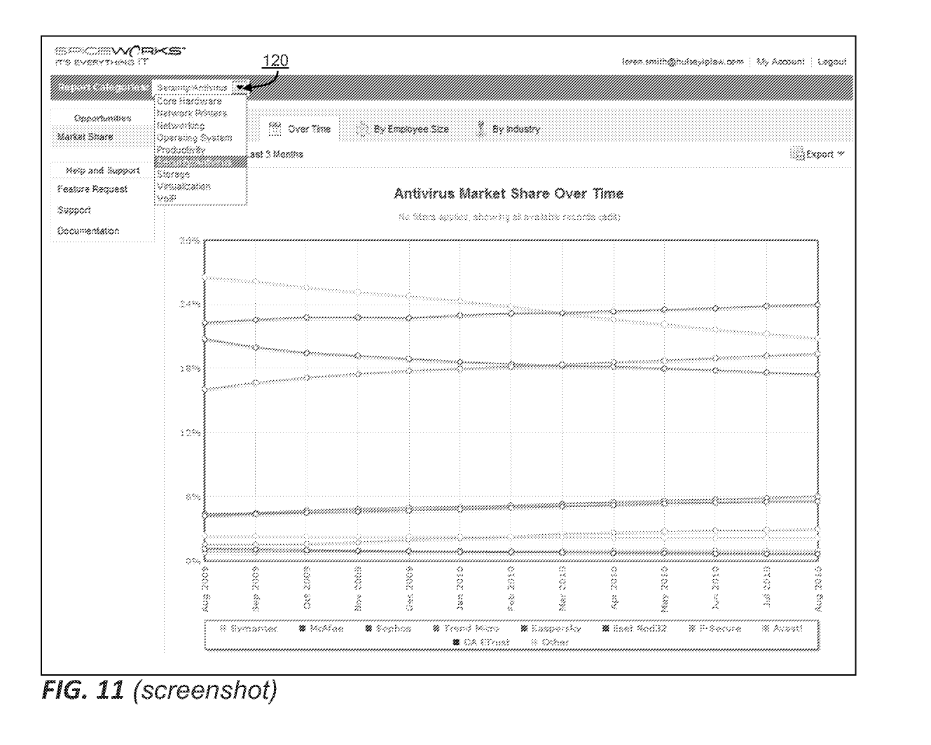

FIG. 11 is a screenshot of a graphical user interface displaying the “Antivirus Market Share Over Time” of users of the network management system. Shown, Security/Antivirus has been selected from drop down menu 120. The line graph depicts the market share of the antivirus providers for the users of the network management system. Antivirus data may be displayed Over Time, By Employee Size, or By Industry.

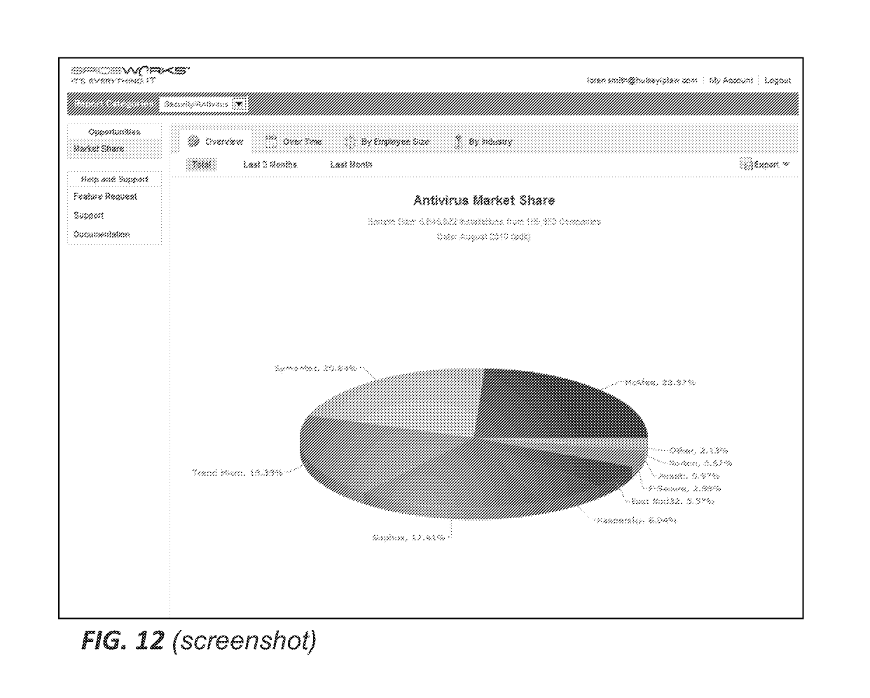

FIG. 12 is a screenshot of a graphical user interface displaying an overview of the Antivirus market share of users of the network management system. The pie graph displays the market share for antivirus providers of users of the local network management system.

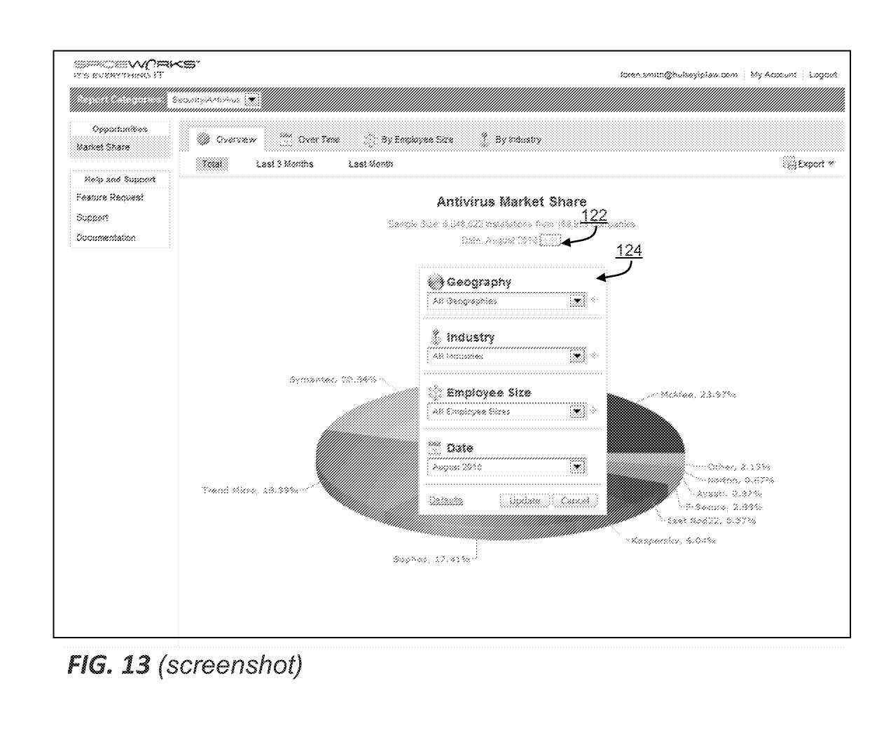

FIG. 13 is a screenshot of a graphical user interface displaying an overview of the Antivirus market share of users of the network management system. This screenshot highlights edit button 122 which is present in all data views in this application and allows a user to further sort data relating to a particular report category. After selecting edit button 122, edit filter box 124 is shown which allows the user to sort data by geography, industry, employee size, and date relating to users of the network management system all Over Time.

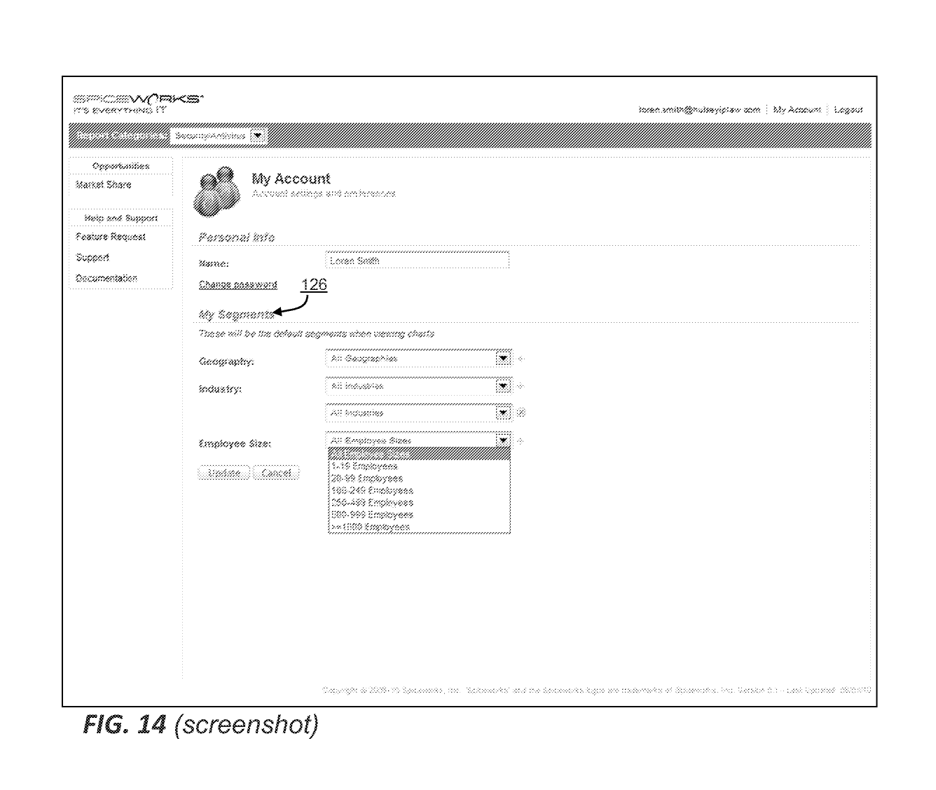

FIG. 14 is a screenshot of a graphical user interface displaying account settings for a user of the closed-loop marketing platform. The disclosed subject matter provides a one-stop interface allowing a user to access data relating to the users of a network management system. Among other options, the account settings view shown in FIG. 14, allows the user to customize data parameters (much as the edit button shown in each screen shot and highlighted in FIG. 13 does), shown as My Segments 126, which are saved and act as default settings for that user. Data parameters include Geography, Industry, and Employee Size concerning the local networks supported by the network management system.

A particularly advantageous aspect of the disclosed subject matter is the vast simplification of obtaining and analyzing data from current IT professionals through a set of easy-to-use functions and a readily understandable interface. Thus providing very detailed information to product developers and marketers regarding potential markets, product placement, potential revenue, etc. This substantially lowers time to market delays caused by traditional market analysis and frees product developers and marketers from the complexity of obtaining and analyzing data.

The following features of the network management system insure a substantial number of users will utilize the network management system. In turn, this insures an ever-expanding database of constantly updated and accurate data regarding IT assets, IT administrators and other users, and company information that is critical to technical product and service providers. More specifically, the network management system provides the ability to inventory and monitor an entire network, operate an IT help desk for the enterprise, troubleshoot the local network, report on network assets and performance, as well as provide the ability to obtain desired products for the network and its components (e.g., computer software, printing supplies), all through a simple one-click management interface.

Inventory functions include the ability to determine what hardware and software are connected to a network. This includes inventorying all the Windows, Mac, and Linux PCs and servers, routers, printers and any other IP-based devices on a network. The network management system supports discovering what software packages, services, hot fixes, and patches are installed on the computers on a network. This includes the function of readily accessing service tags, which may be especially helpful when a need exists to contact a personal computer or other product manufacturer for support.

There is the ability to acquire the MAC (media access control) addresses for the computers on a network in order to easily sort out all network cables and ports. Moreover, the user interface helps define and track custom attributes such as warranty, expiry date, purchase price, and more.

The network management system further enables tracking manual assets such as monitors, projectors, cell phones, or other assets, as desired, as well as to “tag” assets by entering searchable, free-form notes directly into the present system on any asset in the system. Automatically running and updating an inventory multiple times a day, while staying on top of software compliance by knowing how many software licenses you're using relative to how many you've purchased all key benefits of the present disclosure.

Further, the network management system facilitates monitoring a network to determine what is working, not working, and what needs attention. Using the present system permits proactive alerts to low hard drive capacity, low printer ink and toner, or servers that are offline. These alerts can be altered to whatever capacity limits the IT administrator desires, such as when a hard drive reaches 80% capacity or if the antivirus software subscription will expire within 2 weeks. Moreover, the IT administrator may be notified when users install unauthorized software or un-install critical software. The network management system allows for entering the number of licenses a network should have for a software package and will notify the IT administrator when the network exceeds the license allotment. Doing so ensures that the network stays compliant with the allowed licenses. The IT administrator will know when someone creates a Windows user account, thus avoiding the use of phantom network accounts.

Using a Web browser desktop-like interface/model, the network management system provides integrated asset discovery for hardware and software, as well as manual asset entry. Asset monitoring for hardware and software, including user-definable custom Information and notes may the system interactive with the user. Scheduling, automatic updates, and user-definable rules for asset discovery/identification and monitors are also provided. The method and system aid in establishing a community of similarly situated users, including direct feedback functions, the ability to invite a friend, and administration of a console Web-application. Notifications, integrated Help desk and report, and hosted vs. local deployments are also included.

The network management system may be loaded fully or partially by adding only the functionality required on the IT administrator's desktop or parts of it may be hosted. In the hosted configuration, the onsite collection container is “local,” but the server and DB are hosted off premise. The onsite collection container is pluggable and provides a bridge to the assets under management. Multiple collection containers are supported for one installation to handle scalability and connectivity constraints due to number of managed assets and their location.

A Web browser desktop interface is provided to make the information or analysis needed for a given management or IT related task be a single action or click away from any previous action. This is done through multiple methods and includes up-front analysis of possible items of interest and clean views of the minimum amount of useful information. The application runs outside of the browser, so if the browser is closed, the system will effectively be turned “off” from a user interface perspective, but still actively collect, monitor and analyze computer and network data in the background. While the browser user interface is open/active, it provides current feedback and allows any element to be “clickable” for more detailed data.

The user interface main page continually provides relevant summary data of the computer network or enterprise system. The main page may provide notifications for completed operations (scheduled), alerts that have triggered from a monitor, and basic summary stats of inventory for hardware. New machines may be found as part of scheduled discovery routines. Total machines of various “types” may be grouped or ungrouped and basic summary stats of inventory for software may be collected and generated.

Top installed packages, licenses overused, and recently Installed Software may be recorded and displayed. Also, pending operations, updates waiting for various software systems, as well as inventory criteria (rules) for hardware and software may be presented. Community breaking news and information may be provided. DNS status flagging possible issues with DNS and active directory status flagging possible issues with Active Directory may be displayed, as well as assets discovered or under management. The interface may also show hot fixes deployed to assets, services installed/running/stopped on assets, and trouble tickets open/closed/past due/awaiting response. Furthermore, software packages under management may be reported.

In operation, a user, (e.g. an IT administrator) will install software on a desktop or server machine (e.g. windows box). The user launches the present system software application or it may be automatically initiated via an installation Wizard, prompting the user for their name to register. From there, the application automatically scans the networks attached to desktop machine and locates and collects information about the networks connected devices that they typically manage on an ongoing basis. An aspect of the present disclosure then schedules a job (thread or executable) that begins probing the network across their network for machines/services, etc. In an alternate embodiment of the present disclosure the probing of the system may be done as a single or multi-pass procedure.

An IT administrator may change and configure options that control the behavior of the network management system, but none of this is required for initial operation. These options include manager account passwords (if there are any), adding additional network ranges or names to scan, adding assets manually, and manually added additional information such as building location, asset tag or any other related information that they want to track.

Assets may be automatically grouped by common relevant aspects, including software installed, type of hardware (CPU type/speed, OS, IP/subnet, manufacturer, type (laptop, desktop, server, etc.), memory size, disk space, service, and any hot fixes that may have been installed. Also, location, purchase price, purchase date, asset tag or any other attribute may be manually entered by the IT administrator.

The network management system discovers hardware using an integrated collection container that employs standard remote management access techniques (such as WMI and SNMP) to obtain information from network assets. This collection container is extendable such that future version of the product may add support for additional discovery techniques without changing the application user interface.

A key aspect of the network management system's discovery approach is the ability to discover distinct and disparate types of assets. After considering the information truly needed from these disparate asset types for the IT administrator to do their job, the electronically available asset information from these devices and other sources is normalized to be in a consistently useful form. In this way, assets such as Windows computers, Linux computers, Mac OS X computers, printers, routers, switches, VoIP devices, etc are discovered and processed by the network management system Application.

During the hardware discovery process, a network prospect is probed to see if it supports standard remote access protocols such as WMI, SNMP, SSH, HTTP, etc. If a viable protocol is supported, it is used to collect information about the asset. This asset information may include, but is not limited to manufacturer, model, network identifier, machine name, asset operating system and kernel versions, CPU, memory, networking (IP and MAC address), BIOS version, serial number, disk usage, management web interface, and remote control interface, for instance. After an asset is discovered, manual fields may optionally be filled in on an ad hoc basis by user and include but are not limited to department, cost, dates, etc. along with basic tracking info that will be customer specific.

The network management system integrates automated software discovery, which includes automated discovery of assets that are installable on a computer such as software, services and hot fixes. During the hardware discovery process, if the class of asset supports interrogation of installed assets such as software/hot fixes and/or services, they are automatically collected and automatically associated with this asset and other assets that use similar software/hot fixes/services.

The software discovery process includes making visible certain aspects of whether the software is running, installed, the version number and patch level of the software and any other relevant information about the software.

The network management system includes many useful initial reports that work with zero additional configuration needed by the IT administrator. These reports may be augmented or adjusted if the IT administrator desires. For a given report, the IT administrator may view, print, or export the report date for use outside of the present system (e.g. .pdf, .csv, and .xcl).

The initial reports may include (a) inventory summary; (b) detailed inventory; (c) fixed assets schedule; (d) computers without anti-virus software; (e) computers with anti-virus software; (f) assets that have software running that is not allowed (g) inventory of IP phones; (h) inventory and usage of printers; (h) open Helpdesk tickets; (i) network adapters connected to devices; (j) services on computers; (k) hot fixes on computers; (l) DNS issues (m) recently installed software (n) recently discovered hardware; (o) assets with low disk space, and (p) other items of interest. Reports marked as public may be run by users who are not IT administrators (such as the accounting group, etc) and are accessed through the integrated Helpdesk discussed below.

The network management system supports hosting at a server site and allows complete or partial implementation on the user system. Additionally, various functions may be implemented at various levels of the users hierarchy and only provide information and functionality for those systems down-stream of the particular aspect implemented.

All of the above features of the network management system ensure a wide install base and therefore an immense amount of information to populate the database on which IT product developers may query during the product life cycle.

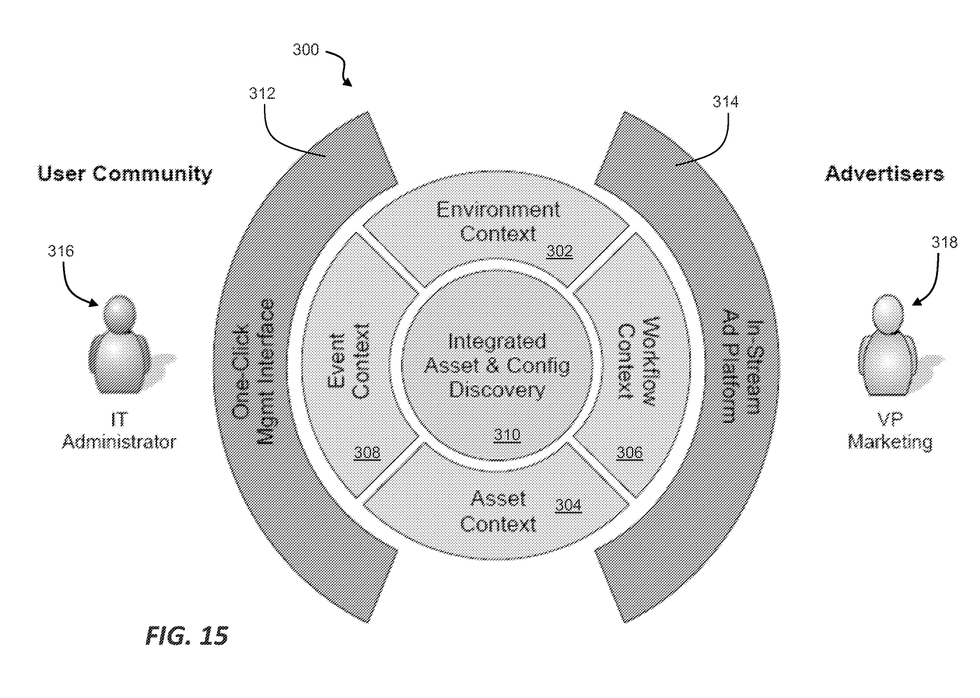

FIG. 15 shows a high-level architectural view of the network management system 300. IT network management system 300 provides enhanced and efficient management capabilities to IT administrators 316, while also providing in-stream targeting advertising opportunities to advertisers 318. IT management system 300 includes environment context 302, workflow context 306, asset context 304, and event context 308. Integrated asset and configuration discovery system 310 discovers assets on the network and provides this information to various contexts 302, 304, 306, and 308. IT administrators 316 may view and manage their networks through one-click management interface 312. Advertisers 318 may produce targeting advertising opportunities through in-stream ad platform 314.

Environment context 302 engine provides the host server the ability to review meta-data with respect to all members of the community, such as what type of business, how many computer, servers or users at the target site. Additionally, the IT network management system is capable of also providing meta-data on all the users, but without any proprietary or confidential data being accessible.

Asset context 304 engine provides the user with the ability to view the network assets on an individual, group or global basis and generate reports, flags and alerts regarding aspects of the system monitored by almost any tracked aspect.

Event context 308 engine provides the user with insight into the system, such as access to critical or proprietary information, monitoring web-server activity as a security measure or general activity of personnel after business hours. Other information relating to the history of events related to the system, such as recent issues flagged by the operating system or IT staff, actions taken by the IT staff on the system and similar operations applied to like systems in the environment may also be provided to the user.

Workflow context 306 engine is a smart engine providing the user with information based on the processes that the user is currently running. Workflow context 306 engine facilitates the acquisition of resources by presenting relevant information and advertising links to the user during the use of the management program. For instance, if an end of year inventory program is running workflow context 306 engine may direct the user to websites where identified or needed computer or network hardware, software or peripherals may be researched and purchased. Additionally, the workflow context 306 engine may simply drive advertisements to the user relating to the user's perceived needs.

The disclosed network management system allows an IT administrator to browse a network for network content, while IT equipment and software vendors obtain targeting opportunities for potential purchasers. Integrated asset and configuration discovery system 310, in the form of software, subroutine, or engine, scans the network and provides information relating to the system and its constituent components, such as type of computer, operating system, etc. Additionally, the present system provides the user with system status (such as low ink), alerts, reports (such as a number of licenses), and work order or purchase order tickets. Advertisers may be integrated into the system through advertisements to provide the user with an option to purchase necessary components, such as software, memory or disk drives.

Further, the disclosed network management system promotes purchase opportunities for buyers and sellers in an IT network environment. For the advertiser/vendor community, this provides an in-stream advertising platform that tailors advertisements and product information to the particular needs of an enterprise network through survey, brand, product education, and switch promotion steps. The disclosed subject matter allows for confidentiality and security within any network. Advertisements provide the user with options to purchase necessary components, such as software, memory or disk drives, represented by the brands and purchase or lead steps. Advertisement revenue allows the network management system to be distributed for free or at a reduced cost to the end user.

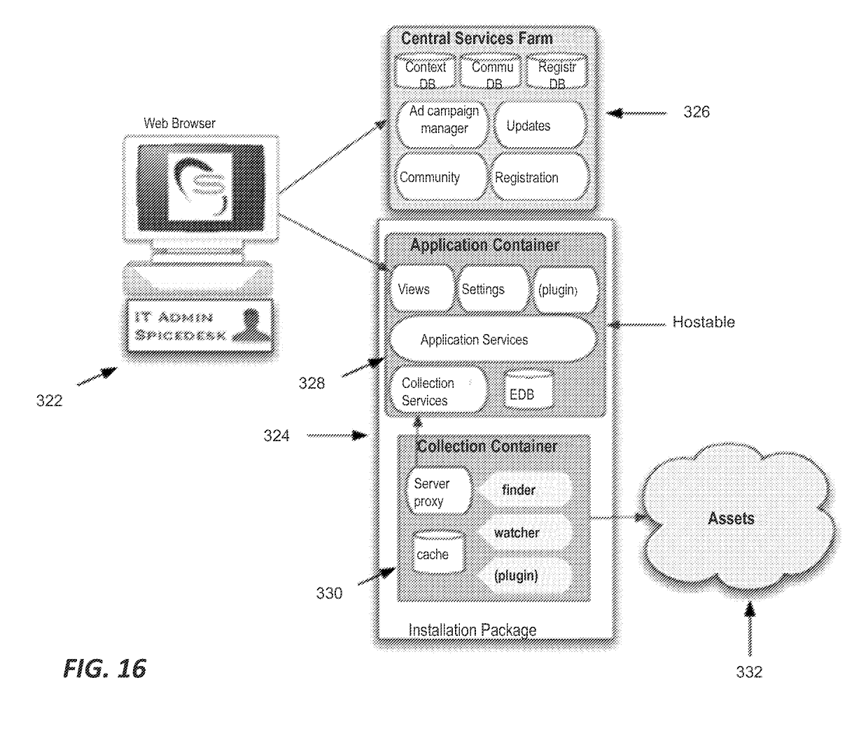

FIG. 16 shows how the network management system supports the activities of an IT network administrator. FIG. 16 depicts a user interface 322, typically manned by the IT administrator of the network. Software module 324 is typically installed on a network to provide the functionality offered by the network management system. Software engine 326 is typically hosted off-site from the user and gathers information from multiple users. Although in a far-flung world-wide organization, engine 326 may be implemented by a third-party for the benefit of the organization or by the IT department of the organization. Application engine 328 contains subroutines that provide the user with such functionality as views, setting, application services, collection of services and a host of other services. This list is meant to be exemplary and not limiting in any manner.

Collection engine 330 provides the user with server proxy, finder, watcher and third party functionality. Engines 328 and 330 may be employed jointly in a network or separately. In a typical installation, engine 330 will be installed at multiple sites in a distributed network 332 or in a network that has several firewalls or security measures, downstream of them and then to provide retrieved information to the application engine 328. Although an IT administrator may change these settings, typically the application automatically determines the appropriate IP addresses, domain names or other information required to gather the information.

The network management system provides a set of easy-to-use functions and information relating to their use through a readily-understandable interface. The network management system substantially frees an IT administrator from the day-to-day complexity of network use. The network management system provides the ability to inventory and monitor an entire network, operate an IT helpdesk for the enterprise, troubleshoot the local network, report on network assets and performance, as well as provide the user with the ability to obtain desired products for the network and its components (e.g., computer software, printing supplies), all through a simple one-click management interface.

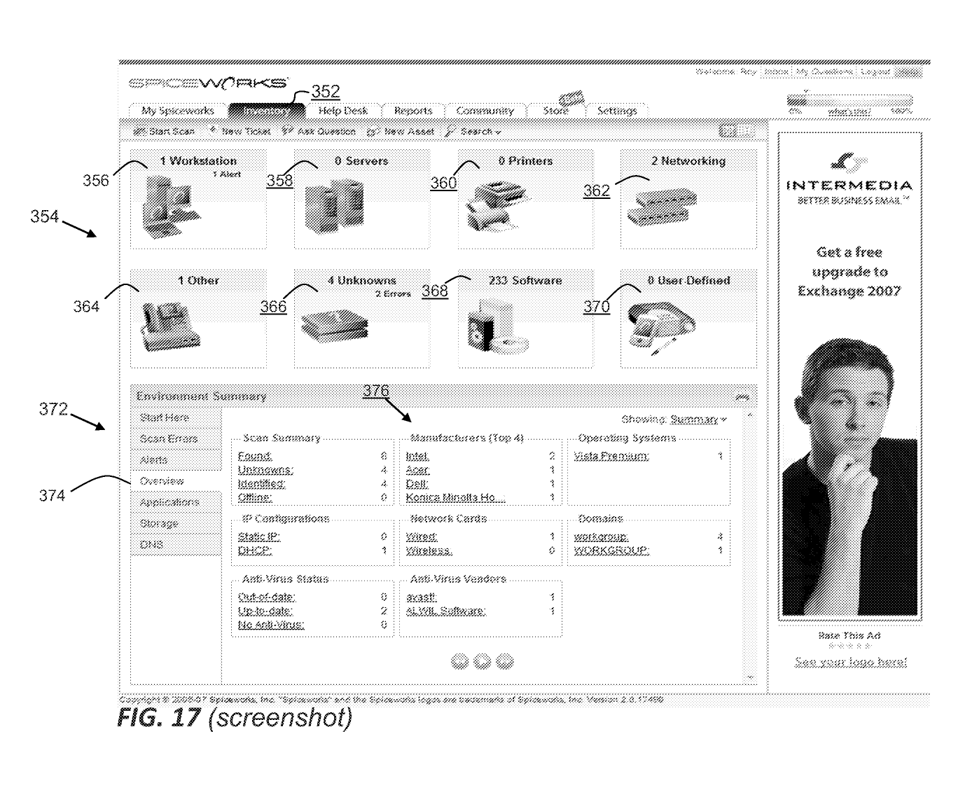

FIG. 17 shows an initial graphical user interface screen shot showing information on how a network administrator may utilize the network management system using a web browser. Specifically, FIG. 17 shows an inventory tab 352 which allows a user to determine the hardware and software installed in an environment and to take action on that data. The top half of the screen (reference numeral 354) shows the major categories that assets are automatically sorted into upon discovery. The categories could include Workstations 356, Servers 358, Printers 360, Networking 362, Other 364, Unknowns 366, Software 368 and any categories defined by the user 370. The bottom half of the screen (reference numeral 372) shows Overview tab 374, displaying the assets discovered in the environment and allowing a user to quickly see any issues. In the embodiment shown, Overview tab 374 shows the top manufacturers, operating systems, anti-virus vendors and status information along with the number of assets discovered in each category. In one embodiment, underlined data indicates that a user may perform some kind of action on that data. For example, under the Manufacturers (Top 4) tab (reference numeral 376), if a user wishes to see assets manufactured by Dell, a user may click the Dell link to receive a filtered view of environment data. Similarly, to see all assets not manufactured by Dell, a user may hover over the Dell link and see ‘Others not like this’ (not shown).

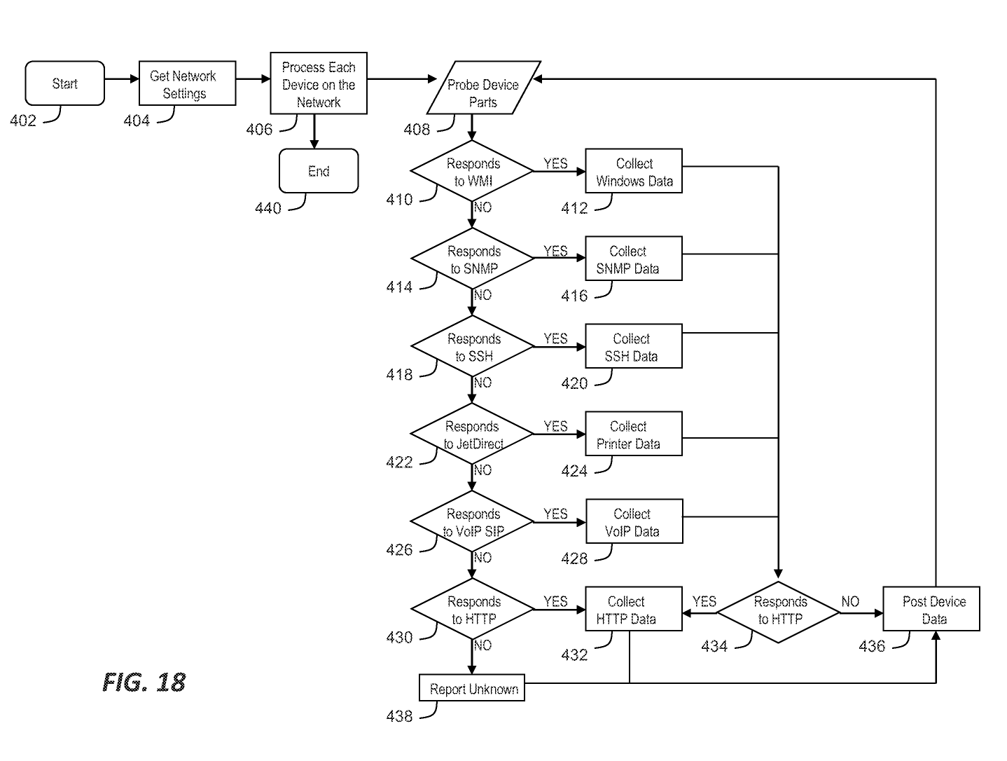

FIG. 18 depicts a schematic flow diagram of integrated asset and configuration discovery system 310 of FIG. 15. In the scanning and discovery process, method steps and parameters are initiated and launched by start 402. Control then passes to obtain network settings step 404. At step 404, integrated asset and configuration and discovery system 310 (FIG. 15) automatically determines network settings, but information may also be manually provided by an IT administrator. For example, an IT administrator could supply information, such as off-site IP addresses, domain names, etc., that is part of the system and needs to be aggregated by central services engine 326 (FIG. 16). Application engine 328 makes this information accessible. This initial information may also include any required security passwords or logins required to access some or all of the systems on the network.

Returning to FIG. 18, at step 404 the network settings are obtained as well as checking of the domain name and the DNS lookup in both directions. Any DNS errors found are aggregated into a top level view so that they later may be corrected by the IT administrator if desired.

An identifier for a computer or device on a TCP/IP network, networks using the TCP/IP protocol route messages based on the IP address of the destination. The format of an IP address is a 32-bit numeric address written as four numbers separated by periods. Each number may be zero to 255. For example, 2.160.10.240 could be an IP address.

Within an isolated network, IP addresses may be assigned at random as long as each one is unique. However, connecting a private network to the Internet requires using registered IP addresses (called Internet addresses) as specified by networking standards. The four numbers in an IP address are used in different ways to identify a particular network and a host on that network. Four regional Internet registries—ARIN, RIPE NCC, LACNIC and APNIC—assign Internet addresses from the following three classes. Class A—supports 16 million hosts on each of 126 networks; Class B—supports 65,000 hosts on each of 16,000 networks; and Class C—supports 254 hosts on each of 2 million networks.

In a 32-bit IP address, the number of bits used to identify the network and the host vary according to the network class of the address. In a Class C network, the first 3 bits, or the high-order bits, are always “110.” The next 21 bits are used to define the Class C network, and the final eight bits are used to identify the host. The IP address is represented in dotted decimal notation of four 8-bit fields, or octets, that have been converted from binary to decimal numbers.

The number of valid networks and hosts available is always 2^{N} (where N equals the number of bits used) minus 2 (one for the all zeros address and one for the all ones address). Thus, for a class C address wherein 8 bits are available for hosts, the number of hosts is 2⁸-2, or 256-2, which is 254.

Support for Ipv6 which allows for a much greater range of IP addresses could also be supported. At step 404, the network management system determines how wide the network is and allocates search protocols based on this measure. For instance, in a Class C network there are 254 potential hosts. Each device on the network has or should have a unique IP address or sub-mask address. If an IP address or DNS name is provided by the IT administrator, a DNS lookup takes place. The network management system confirms the DNS name and IP address associated with it and assures that the IP address defaults to the DNS name and vice-versa. If an IP address or DNS name is not provided, during step 406 the search engine will set the range based on how wide the network is (obtained at step 404) and ping each element to see if it responds. If an element does respond, it is probed to see if it is listed on one of the ports or is a unique name or IP address device. Having “ping”-ed an element received its response, control then passes to step 408 where the element is probed.

Although the following steps are listed in a logical and efficient manner for probing elements on a network, other groupings or searching hierarchies may be employed or plugged in later and not depart from the scope of the present disclosure.

At step 410, the device is probed to see if it responds to WMI. Windows Management Instrumentation (WMI) is a set of extensions to the Windows Management Instrumentation that provides an operating system interface through which instrumented components may provide information and notification. If the device is identified as a WMI device, data is collected at step 412 and control passes to step 434 where a determination as to whether the device responds to HTTP (and/or HTTPS) is made (i.e., has a web server interface). Hypertext Transfer Protocol (HTTP) is a method used to transfer or convey information on the World Wide Web. If the device is found to be a WMI at step 410, the remaining steps 414 through 430 are skipped, since by default the device will not respond to any of the other protocols.

At step 414, the device is probed to see if it responds to SNMP. The simple network management protocol (SNMP) forms part of the internet protocol suite as defined by the Internet Engineering Task Force (IETF). SNMP is used by network management systems to monitor network-attached devices for conditions that warrant administrative attention. It consists of a set of standards for network management, including an application layer protocol, a database schema, and a set of data objects. If at step 414 the device responds, it is identified as a SNMP device and data is collected at step 416. Control passes to step 434 where a determination as to whether the device responds to HTTP is made. The remaining steps 418-430 are skipped.

At step 418 if the device responds, it is identified as a SSH device, data is collected at step 420 and control passes to step 434 where a determination as to whether the device responds to HTTP is made. Steps 422-430 are skipped. Secure Shell or SSH is a set of standards and an associated network protocol that allows establishing a secure channel between a local and a remote computer. It uses public-key cryptography to authenticate the remote computer and (optionally) to allow the remote computer to authenticate the user. Shell commands are then used to obtain the needed information from the asset.

At step 422 if the device responds, it is identified as a JetDirect device, data is collected at step 424 and control passes to step 434 where a determination as to whether the device responds to HTTP is made. Steps 426-430 are skipped. JetDirect is the name of a technology sold by Hewlett-Packard that allows computer printers to be directly attached to a Local Area Network. The most common communication uses TCP/IP port 9100.

At step 426 if the device responds, it is identified as a VoIP SIP, data is collected at step 428 and control passes to step 434 where a determination as to whether the device responds to HTTP is made. Voice over Internet Protocol, also called VoIP, IP Telephony, Internet telephony, Broadband telephony, Broadband Phone and Voice over Broadband is the routing of voice conversations over the Internet or through any other IP-based network.

At step 430 if the device responds, it is identified as an HTTP device and data is collected at step 432. If no response is received, control then passes to step 438 wherein an exception report or alert is generated and forwarded to the IT administrator providing the directions as to how to handle these occurrences.

The reason the device failed to respond or did not respond fully, after being identified as being on the system could be numerous. In this instance the port is identified as being open but is identified as not showing anything on it. This could occur for various reasons, such as the user may not have the security clearance to access the system/device in question or a separate login is required that was not provided. The device may be behind a firewall or other device such as a hub that will not respond.

Once the data is collected control then passes to step 436 wherein the data collect is posted with each device found on the network. Process steps 406 through 438 may be repeated again at a later time to discover new network devices, but a report will only be generated for devices previously identified if the device configuration has changed. This information is stored so that a history of the device may be created and used to compare with itself or other devices similarly configured and equipped.

Trouble shooting devices on the network may be made easier through a snapshot of the device history created through flow diagram of FIG. 18. This process flow also provides the IT administrator the functionality and ability to ensure that each user on the system is appropriately configured with the software, hardware, peripheral access and etc. that their security level or access level requires or allows. Therefore, if a system BIOS or other parameters are changed and a problem occurs, the IT administrator may utilize this tool to identify the change in the systems configuration and take appropriate measures to resolve it.

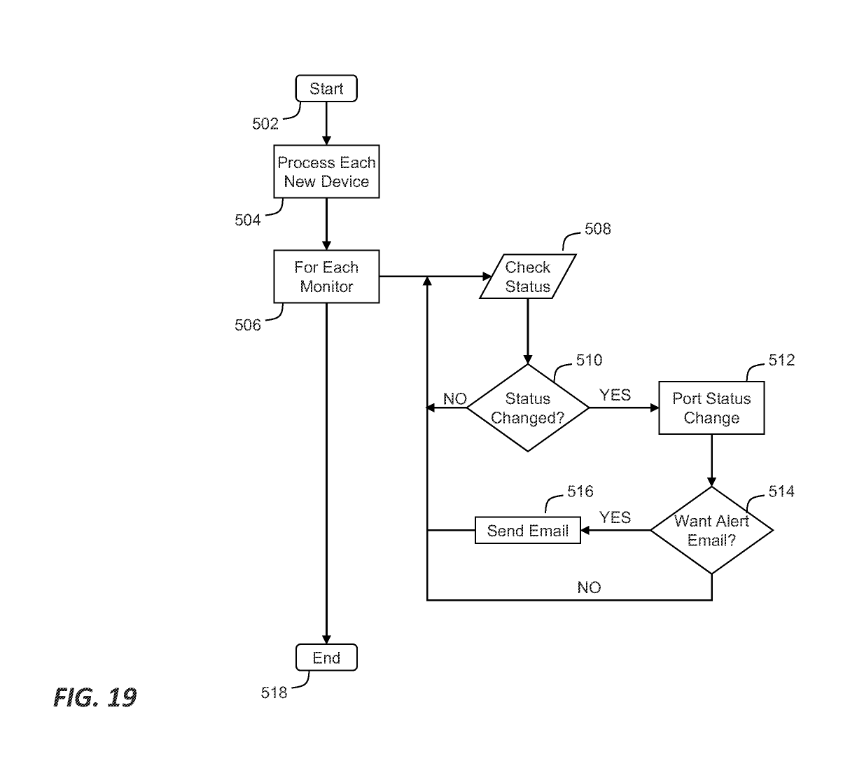

FIG. 19 depicts a schematic diagram of a watcher or monitoring engine. This aspect of the network management system monitors identified devices at periodic times. It mainly looks for devices that switch states between online and offline and sends flags of these events for the IT administrator as discussed below. For large organizations, the monitoring engine may segment the total number of devices and monitor each segment in a rotating fashion as not to over tax the operating systems. Although, this should not be a concern, since the data gathered and transmitted is on the order of 10s of K and requires very little system resources to run. Therefore, in most instances, the user will not even be aware of the programming scanning operation. Alternately, the monitoring engine may be directed to only run when system resources are below a certain level (i.e. below 60% or below 80%) to ensure that productivity is not hampered by the scanning and transmitting of data process.

Returning now to FIG. 19, the monitoring or watcher flow engine is initiated with the parameters set by the IT administrator at step 502. Control then passes to step 504 where each known device is processed. Control then passes to step 506 for each monitor where a check status request is initiated at step 508. Whether the status has changed is checked 510 and if the result of the check status is a positive, i.e., the status has changed, the status change is posted at step 512. If the check status request is a negative, i.e., a no result, the process terminates.

Once the change is posted at step 512, control then passes to step 514, where a determination is made, in compliance with the IT administrator set up instructions, to send an email or other type alert, such as creating an exception report, or log. If the determination at step 514 is a no, then the process terminates, although the data is still stored with the device showing the time of the last scan and its results. This data may remain indefinitely or be periodically culled using a FIFO method over a set time period. If the instructions are affirmative at step 514 to send an email, control passes to step 516 where an email or some other type alert is directed to the party or parties designated by the IT administrator.

The watcher flow or monitoring engine continually performs the various described functions at the period intervals set up for the monitoring process until the process is terminated or altered by the IT administrator.

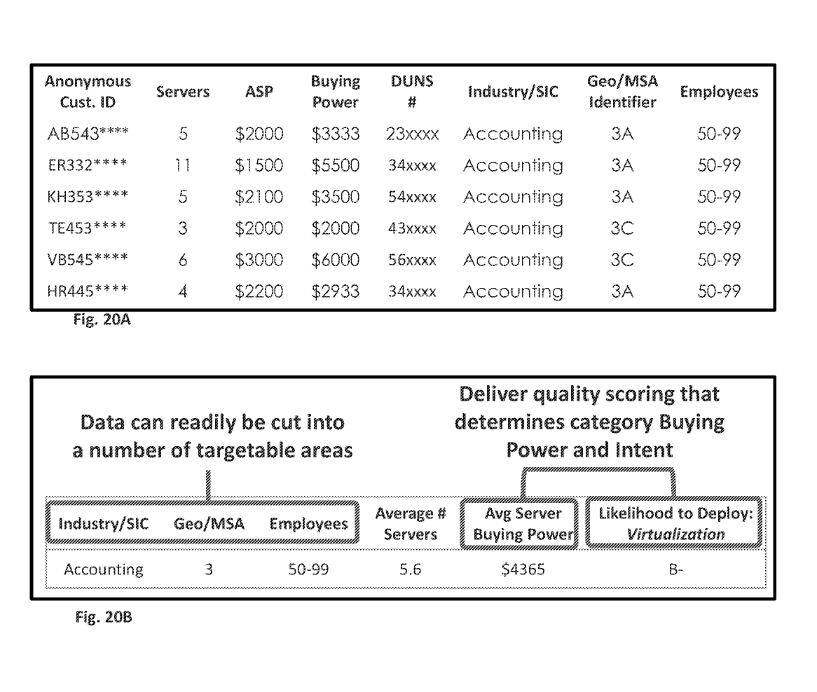

Using the disclosed subject matter users are able to make smarter business decisions by utilizing the information and data from the database associated with the network management systems. As has been previously discussed, this data is actual network data and not projections. By using actual data, users are able to more accurately measure market share and potential buying power of the particular market segment the user is interested in. FIGS. 20A and 20B depict charts of exemplary data depicting the market score feature of the disclosed subject matter. The market score feature allows the user to sort and classify data according to both the database and commercially available resources such as Dun & Bradstreet® (a registered trademark of Dun & Bradstreet International, Ltd.). This way data can be sorted and classified by Industry/SIC code; Geo/MSA code, number of employees, etc. Additionally, through the market score feature, the closed look marketing system can calculate the buying power and likelihood of deployment of a particular product offering into a market segment and even a particular user of the network management system. Generally, the particular user of the network management system would not be made known and would be given an anonymous customer ID and an obscured Dun & Bradstreet® number. For example, if a user was seeking server sales opportunities into new or existing accounts, the market score feature could provide a target list breaking down the strongest markets. By leveraging the data contained in the database associated with the network management systems, market score can assist with: (i) determining the greatest opportunities for product refresh, growth, and competitive exposure by calculating and analyzing hardware to employee ratios; (ii)_identify leading edge and early technology adopters as well as mission-critical IT deployments as highest value targets by noting the presence of high-end hardware/software and/or new technologies; (iii) identify advanced computing environments by noting the use and existence of high-end database systems, virtualization deployments, and SAN/NAS (Storage Area Network/Network Attached Storage) usage which require significant computing power; (iv) identify and present IT spending trends; (v) identify product refresh (e.g. purchasing replacement equipment) and/or IT service opportunities by analyzing legacy system and software ratios; (vi) align categories of usage (e.g. help desk, new employment, etc.) with purchasing trends and hardware burn-through; (vii) providing scoring that is based on active directory data and not on estimates or polls/surveys; and (viii) identifying and targeting forward-leaning organizations for innovative technology adaptation by noting the presence of cloud environments.

It will be apparent to those skilled in the art that various modifications and variations may be made in the above disclosure and aspects of the disclosure without departing from the scope or intent of the disclosure. Other embodiments of the disclosure will be apparent to those skilled in the art from consideration of the specification and practice of the disclosure disclosed herein. It is intended that the specification and examples be considered as exemplary only.

What is claimed is:

1. An interactive online closed loop marketing method for marketing of a technical product or service to users of a plurality of network management systems, the method comprising the steps of:
requesting data from a database associated with the network management systems in response to a query from a third party, said database containing information relating to users and their IT asset inventory information;
receiving said data from said database;
storing said data on a tangible computer readable medium; and
displaying said data to said third party via an online graphical user interface.

2. The method of claim 1, additionally comprising the following steps:
displaying a survey data subset according to a first criteria, said first criteria received from said third party, said survey data subset at least a portion of said data;
assisting said third party in designing a survey, said survey regarding the technical product or service;
allowing said third party to select at least one survey recipient, wherein said survey recipient is at least one of the users associated with said survey data subset;
delivering said survey to said survey recipient via the network management systems;
receiving at least one survey response from said survey recipient;
storing said survey response on said tangible computer readable medium; and
displaying said survey response to said third party via said online graphical user interface.

3. The method of claim 2, wherein each of the network management systems perform the following steps:
initiating an inventory of a plurality of IT devices associated with a local IT network;
generating a profile associated with at least a subset of IT devices from said plurality of IT devices, said profile comprising device information regarding said subset of IT devices;
determining the operational status of said subset of IT devices; and
monitoring said operational status of said subset of IT devices.

4. The method of claim 2, additionally comprising the following steps:
requesting an advertising data subset from said database, said advertising data subset according to a second criteria, said second criteria received from said third party;
displaying said advertising data subset via said online graphical user interface;
allowing said third party to select at least one advertising recipient, wherein said advertising recipient is at least one of the users associated with said advertising data subset;
delivering an advertisement to said advertising recipient via the network management systems;
tracking the results of said advertisement, said results including impressions, clicks, and/or sales associated with said advertisement;
storing said results on said tangible computer readable medium; and
displaying and/or reporting said results to said third party via said online graphical user interface.

5. The method of claim 1, wherein each of the network management systems perform the following steps:
initiating an inventory of a plurality of IT devices associated with a local IT network;
generating a profile associated with at least a subset of IT devices from said plurality of IT devices, said profile comprising device information regarding said subset of IT devices;
determining the operational status of said subset of IT devices; and
monitoring said operational status of said subset of IT devices.

6. The method of claim 1, additionally comprising the following steps:
requesting an advertising data subset from said database, said advertising data subset according to a second criteria, said second criteria received from said third party;
displaying said advertising data subset via said online graphical user interface;
allowing said third party to select at least one advertising recipient, wherein said advertising recipient is at least one of the users associated with said advertising data subset;
delivering an advertisement to said advertising recipient via the network management systems;
tracking the results of said advertisement, said results including impressions, clicks, and/or sales associated with said advertisement;
storing said results on said tangible computer readable medium; and
displaying and/or reporting said results to said third party via said online graphical user interface.

7. The method of claim 6, wherein each of the network management systems perform the following steps:
initiating an inventory of a plurality of IT devices associated with a local IT network;
generating a profile associated with at least a subset of IT devices from said plurality of IT devices, said profile comprising device information regarding said subset of IT devices;
determining the operational status of said subset of IT devices; and
monitoring said operational status of said subset of IT devices.

8. An interactive online closed loop marketing platform, the platform comprising:
an online graphical user interface providing third party access to a database containing information from a plurality of network management systems, wherein said user interface comprises:
a user access component providing said third party access to said user interface;
a data component, said data component requesting and receiving data from a database according to a set of criteria, said database containing information relating to users and their IT asset inventory information gathered from said network management systems, said criteria provided by said third party; and
a display component, said display component displaying said received data.

9. The platform of claim 8, wherein each of said network management systems comprises:
an inventory component, said inventory component taking an inventory of a plurality of IT devices associated with a local IT network;
a profile generation component, said profile generation component generating a profile, said profile associated with at least a subset of IT devices from said plurality of IT devices, said profile comprising device information regarding said subset of IT devices;
a status component, said status component determining and monitoring the operational status of said subset of IT devices;
an information component, said information component accepting input from a user of said network management system, said input including user information, said user information associated with said local IT network.

10. The platform of claim 8, wherein said user interface additionally comprises a survey component assisting said third party in designing and delivering a survey to a pre-defined first subset of said users, said survey delivered via said network management systems.

11. The platform of claim 10, wherein each of said network management systems comprises:
an inventory component, said inventory component taking an inventory of a plurality of IT devices associated with a local IT network;
a profile generation component, said profile generation component generating a profile, said profile associated with at least a subset of IT devices from said plurality of IT devices, said profile comprising device information regarding said subset of IT devices;
a status component, said status component determining and monitoring the operational status of said subset of IT devices;
an information component, said information component accepting input from a user of said network management system, said input including user information, said user information associated with said local IT network.

12. The platform of claim 10, wherein said user interface additionally comprises:
an advertisement component providing advertisement delivery to a pre-defined second subset of said users, said advertisement delivered via said network management system; and
a reporting component providing tracking and result information relating to said survey and said advertisement.

13. The platform of claim 12, wherein each of said network management systems comprises:
an inventory component, said inventory component taking an inventory of a plurality of IT devices associated with a local IT network;
a profile generation component, said profile generation component generating a profile, said profile associated with at least a subset of IT devices from said plurality of IT devices, said profile comprising device information regarding said subset of IT devices;
a status component, said status component determining and monitoring the operational status of said subset of IT devices;
an information component, said information component accepting input from a user of said network management system, said input including user information, said user information associated with said local IT network.

14. The platform of claim 8, wherein said user interface additionally comprises:
an advertisement component providing advertisement delivery to a pre-defined second subset of said users, said advertisement delivered via said network management system; and
a reporting component providing tracking and result information relating to said survey and said advertisement.

15. A method for the closed loop marketing of an IT product or service to users of a plurality of online network management systems, comprising the steps of:
compiling data relating to the users of said online network management systems in a database, wherein the online network management systems provides an IT inventory monitoring and reporting platform for a plurality of local IT networks;
displaying said data in a user interface allowing third parties to sort said data;
surveying a selected group of the users of said network management systems through a user interface of said online marketing platform;
displaying the results of said surveys in said user interface;
delivering an advertisement directly to targeted users of said network management systems through said user interface associated with said online network management systems;
tracking the sales results of the IT product or service to said targeted users of said network management systems; and
displaying the sales results as a report in said user interface.
